(19) United States
(12) Patent Application Publication
(10) Pub. No.: US 2010/0178954 A1
(43) Pub. Date: Jul. 15, 2010

(54) CELLULAR TELEPHONE WITH A MAGNIFICATION DEVICE DEVICE AND AN ILLUMINATION

(76) Inventor: James Dean STATHIS, Towaco, NJ (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/351,303

(22) Filed: Jan. 9, 2009

(51) Int. Cl. H04M 1/00

(52) U.S. Cl. 455/556.1

(57) ABSTRACT

A cellular telephone with a magnification device, an illumination device, a display device, and operating system implementing basic functions is disclosed.

### FIELD OF THE INVENTION

The present invention relates generally to cellular telephones and more specifically to an improved cellular telephone with a magnification device and an illumination device.

### BACKGROUND OF THE INVENTION

Cellular telephones increasingly have become a necessity in society. Some users may rely upon a cellular telephone to provide more functions than that of a basic telephone. In general, cellular telephones may offer users a variety of functions such as accessing the internet, creating video streams, sending video streams, receiving video streams, creating text messages, sending text messages, receiving text messages, capturing pictures, sending pictures, receiving pictures, gaming, calculating, scheduling, sending telephone calls, receiving telephone calls, and/or other functions associated with a cellular telephone. As cellular telephone technology continues to evolve, the type of functions offered to cellular telephone users may become more and more complex.

Despite this recent evolution in cellular telephone technology, many users may prefer a cellular telephone that provides a limited number of basic functions. For this reason, the cellular telephone industry may continue to offer cellular telephones directed to meeting the basic needs of these cellular telephone users. In addition, many cellular telephone users may desire to combine multiple devices that provide varying functions into a single device for convenience purposes.

### SUMMARY OF THE INVENTION

Accordingly, at least one exemplary embodiment is directed to a cellular telephone device. This embodiment may include an upper portion, upper portion may include one or more magnifiers internal to the upper portion, and a lower portion, the lower portion may include at least a display, wherein the upper portion is hinged to the lower portion.

Another embodiment may provide a cellular telephone device. This embodiment may include an upper portion, the upper portion may include one or more magnifiers internal to the upper portion, and one or more illuminators, and a lower portion, the lower portion may include at least a display, wherein the upper portion is hinged to the lower portion.

An additional embodiment may provide a cellular telephone device. This embodiment may include a single piece, the single piece may include at least one or more magnifiers internal to the single piece, one or more illuminators, a display, and a keyboard, wherein the keyboard comprises one or more symbols.

An additional embodiment may provide a cellular telephone device. This embodiment may include a first side and a second side. The first side may include a display device. The second side may include a magnification device and an illumination device. The magnification device may include a plurality of magnification lens internal to the magnification device. The illumination device may include one or more illuminators. The first side may be coupled to the second side such that the magnification device magnifies and the illumination device illuminates in a direction opposite the display device.

An additional embodiment may provide a cellular telephone device. This embodiment may include a first side and a second side. The first side may include a display device. The second side may include a camera device and an illumination device. The camera device may include a plurality of magnification lens internal to the camera device. The illumination device may include one or more illuminators. The first side may be coupled to the second side such that the camera device magnifies and the illumination device illuminates in a direction opposite the display device.

An additional embodiment may provide a cellular telephone device. This embodiment may include a first side and a second side. The first side may include a display device. The display device may include at least one of a liquid crystal display and a plasma display. The second side may include a camera device and an illumination device. The camera device may include a plurality of magnification lens internal to the camera device. The illumination device may include one or more illuminators. The first side may be coupled to the second side such that the camera device magnifies and the illumination device illuminates in a direction opposite the display device.

These and other embodiments and advantages of the present inventions will become apparent from the following detailed description, taken in conjunction with the accompanying drawings, illustrating by way of example the principles of the inventions.

### BRIEF DESCRIPTION OF THE DRAWINGS

FIG. 1 illustrates a perspective view of a cellular telephone with a magnification device and an illumination device according to at least one embodiment of the invention;

FIG. 2 illustrates a perspective view of a cellular telephone with a magnification device and an illumination device in a closed position according to at least one embodiment of the invention;

FIG. 3 illustrates a perspective view of a side of a cellular telephone with a magnification device and an illumination device in an open position according to at least one embodiment of the invention;

FIG. 4 is an exemplary illustration of a top of a cellular telephone with a magnification device and an illumination device while magnifying an object of interest in an open position according to at least one embodiment of the invention;

FIG. 5 is an exemplary flowchart illustrating the method of operation of one or more illuminators associated with a cellular telephone with a magnification device and an illumination device according to at least one embodiment of the invention;

FIG. 6 is an exemplary block diagram illustrating one or more functions performed by an operating system associated with a cellular telephone with a magnification device and an illumination device according to at least one embodiment of the invention;

FIG. 7 illustrates a perspective view of the outward side of a cellular telephone with a magnification device and an illumination device according to at least one embodiment of the invention;

FIG. 8 illustrates another perspective view of a side of a cellular telephone with a magnification device and an illumination device in an open position according to at least one embodiment of the invention;

FIG. 9A illustrates a perspective view of the inward side of a cellular telephone with a display device displaying an exemplary menu of functions of the cellular telephone according to at least one embodiment of the invention;

FIG. 9B illustrates a perspective view of the inward side of a cellular telephone with a display device displaying an exemplary menu of magnifier functions of the cellular telephone according to at least one embodiment of the invention;

FIG. 10A illustrates a perspective view of the front side of a single piece cellular telephone according to at least one embodiment of the invention; and

FIG. 10B illustrates a perspective view of the back side of a single piece cellular telephone according to at least one embodiment of the invention.

### DETAILED DESCRIPTION

The following description is intended to convey a thorough understanding of the embodiments described by providing a number of specific embodiments and details involving a cellular telephone with a magnification device and an illumination device. It should be appreciated, however, that the embodiments of the present inventions are not limited to these specific embodiments and details, which are exemplary only. It is further understood that one possessing ordinary skill in the art, in light of known devices, would appreciate the use of the various embodiments for their intended purposes and benefits in any number of alternative embodiments, depending upon specific design applications and/or other needs or preferences.

A cellular telephone with a magnification device, an illumination device, and/or an OS that implements basic functions may be used to enlarge and/or illuminate one or more objects by individuals with impaired and/or limited vision. OS may include any software and/or hardware used to implement and/or control one or more functions associated with an electrical device.

These individuals may include those that may be classified as a senior citizen, mentally challenged, vision impaired, vision limited, and/or any other classification associated with a need for vision assistance. In various embodiments, individuals that may not need vision assistance may use a cellular telephone with a magnification device, an illumination device, and/or an OS that implements basic functions for the convenience of such functions being associated with a single device.

For example, a cellular telephone may be used to perform additional functions that traditionally may not be performed by a cellular telephone. These functions may include providing a cellular telephone user with a magnification device and/or an illumination device.

According to various exemplary embodiments, a magnification device may include one or more magnifiers. A magnifier may be associated with a lens made of a glass-type material, plastic-type material, polymer-type material, and/or any other material that may be used to enlarge the apparent size of one or more objects of interest. For example, a lens may include a concave shape lens, a biconvex shape lens, a plano-convex shape lens, a convex-concave shape lens, a meniscus shape lens, a plano-concave shape lens, a biconcave shape lens, a fresnel shape lens, and/or any other lens shape that may be used to magnify an object of interest. The preferred embodiment may include one or more magnifiers associated with one or more concave lenses.

An object of interest may include any object a user of a cellular telephone may be viewing. In various embodiments, one or more magnifiers may be configured to be internal to a cellular telephone such that the magnifier portion of the cellular telephone may lay flush with one or more objects of interest. One or more magnifiers being configured to be internal to a cellular telephone may include the one or more magnifiers being fully integrated into an upper portion and/or lower portion of a cellular telephone.

According to various exemplary embodiments, an illumination device may include one or more illuminators. An illuminator may be associated with one or more light-emitting diodes (“LED”) and/or any other light source that may be used to illuminate one or more objects of interest. In various embodiments, one or more illuminators may be configured to be internal to a cellular telephone such that the illuminator portion of the cellular telephone may lay flush with one or more objects of interest. In addition, one or more illuminators may also be positioned within the same plane as one or more magnifiers.

A cellular telephone may include an operating system (“OS”) configured to implement basic functions. In various embodiments, these basic functions may include sending and/or receiving telephone calls, adding, deleting, editing, and/or accessing contacts associated with a contacts list, programming and/or using speed dial, turning on and/or off one or more illuminators, and/or any other basic function associated with a cellular telephone OS.

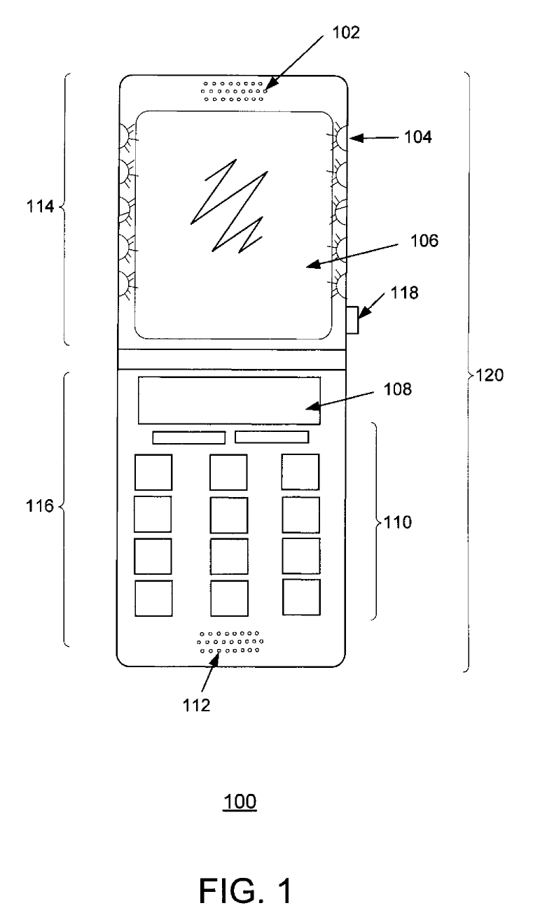

Referring now to FIG. 1, a perspective view of a cellular telephone with a magnification device and an illumination device 100 according to at least one embodiment of the invention is illustrated. Cellular telephone 120 may include upper portion 114 and/or lower portion 116. Upper portion 114 may be hinged to lower portion 116 such that upper portion 114 and lower portion 116 may open to a 180° angle such that cellular telephone 120 may lay flush with one or more objects of interest. In various embodiments, upper portion 114 and lower portion 116 may open to one or more angles less than a 180° angle in addition to a 180° angle. For example, upper portion 114 and lower portion 116 may open to a 160° angle in addition to a 180° angle. While upper portion 114 and lower portion 116 may be illustrated as extending lengthwise along a vertical axis, other configurations may be realized. For example, upper portion 114 and lower portion 116 may also extend lengthwise along a horizontal axis.

Upper portion 114 of cellular telephone 120 may include magnifier 106, speaker 102, illuminator 104, and/or on/off button for one or more illuminators 118. It should be noted that the term magnifier may refer to one or more magnifiers. It should also be noted that the term illuminator may refer to one or more illuminators.

In various embodiments, upper portion 114 may include magnifier 106 that may be internal to upper portion 114. Magnifier 106 may include a lens made of a glass-type material, plastic-type material, polymer-type material, and/or any other material that may be used to enlarge the apparent size of one or more objects of interest. As illustrated in FIG. 1, magnifier 106 may include a transparent material. In another embodiment, magnifier 106 may include a translucent material. In yet another embodiment, magnifier 106 may include a colored material.

As illustrated in FIG. 1, magnifier 106 may be rectangular in shape. In addition, the length and/or width of magnifier 106 may extend closer to and/or farther away from the boundary of upper portion 114 according to design preferences. While magnifier 106 may be illustrated as having a rectangular shape, other shapes and/or configurations may be realized according to design preferences.

Magnifier 106 may provide magnification at one or more magnification strengths. For example, magnifier 106 may provide increasing magnification strength as the distance between magnifier 106 and an object of interest increases. Magnifier 106 may also provide decreasing magnification strength as the distance between magnifier 106 and an object of interest decreases.

According to various exemplary embodiments (not shown), magnifier 106 in upper portion 114 having one magnification strength may be replaced by magnifier 106 having a different magnification strength by a user of cellular telephone 120. For example, a user of cellular telephone 120 may replace magnifier 106 having a magnification strength of 1.25 with magnifier 106 having a magnification strength of 2.50 to meet the vision preferences of the user.

Speaker 102 may include any hardware and/or software used by those of ordinary skill in the art to amplify one or more electrical signals in a form recognizable by a human ear. In various embodiments, speaker 102 may include any electrical device known to those of ordinary skill in the art used to substantially increase amplification for the hearing impaired.

In various embodiments, upper portion 114 may include illuminator 104 that may be internal to upper portion 114. Illuminator 104 may include one or more LEDs and/or any other light source that may be used to illuminate an object of interest. Illuminator 104 may also include one or more LEDs of varying colors, for example, red, blue, white, yellow, green, orange, indigo, violet, and/or any other color associated with a LED.

Illuminator 104 may be configured to be internal to upper portion 114 of cellular telephone 120 such that upper portion 114 may lay flush with one or more objects of interest. In addition, illuminator 104 may also be positioned within the same plane as magnifier 106. Illuminator 104 may also be positioned to surround magnifier 106. For example, illuminator 104 may be positioned to illuminate towards magnifier 106 and/or away from magnifier 106 (e.g., toward an object of interest).

According to various exemplary embodiments, illuminator 104 may be connected to a power source such that one or more electrical signals may be used to turn illuminator 104 on and/or off. Illuminator 104 may be configured to turn on when upper portion 114 and lower portion 116 are in an open position. In addition, illuminator 104 may be associated with timing circuitry. For example, a timing circuit may include a digital counter that may count from zero to a predetermined amount of time. Illuminator 104 may automatically turn off if upper portion 114 and lower portion 116 remain open past a predetermined amount of time. Turning off illuminator 104 if a predetermined amount of time has passed may include ending a flow of electrical signals from a power source to illuminator 104. A predetermined amount of time may be established by the implementers of cellular telephone 120.

In addition, illuminator 104 may be configured to turn on (e.g., illuminate) when on/off button 118 has been turned to an on position. Furthermore, illuminator 104 may be configured to turn off (e.g., stop illuminating) when on/off button 118 has been turned to an off position. By way of a non-limiting example, if the implementers of cellular telephone 120 established a predetermined amount of time of 30 seconds, illuminator 104 may turn off if upper portion 114 and lower portion 116 remain open past 30 seconds. Illuminator 104 may turn on if, for example, a cellular telephone user turns on/off button 118 to an on position. In various embodiments, a timer may be initialized when illuminator 104 is turned on using on/off button 118. In yet another embodiment, a timer may not be initialized when illuminator 104 is turned on using on/off button 118. In various embodiments, illuminator 104 may be turned off by turning on/off button 118 to an off position.

Lower portion 116 of cellular telephone 120 may include microphone 112, keyboard 110, and/or display 108. Keyboard 110 may include one or more keys with one or more enlarged symbols. For example, a key associated with keyboard 110 may have an enlarged number one (e.g., 1). An enlarged symbol may include a symbol that has been printed using the majority of surface area of a key. In one embodiment, keyboard 110 may include one or more enlarged symbols for ease of sight. In another embodiment, keyboard 110 may include one or more standard size symbols (i.e., without enlarged symbols).

Microphone 112 may include any hardware and/or software (e.g., transducer and/or sensor) used by those of ordinary skill in the art to convert sound into one or more electrical signals. Display 108 may include any digital display used by those of ordinary skill in the art to digitally display one or more symbols.

In various embodiments, one or more components associated with upper portion 114 may be associated with lower portion 116. Furthermore, one or more components associated with lower portion 116 may be associated with upper portion 114.

In one embodiment (not shown), cellular telephone 120 may include a single piece device. For example, a single piece device may include one or more magnifiers 106 that may be configured to be internal to the single piece device. In addition, a single piece device may include one or more illuminators 104, a display 108, and/or a keyboard 110. In various embodiments, illuminator 104 may illuminate toward a magnifier 106 and away from a magnifier 106 (e.g., toward an object of interest). A single piece device may include a cellular telephone whereby the portions (i.e., a region associated with a magnifier and a region associated with a keyboard) may reside at opposite ends of each other.

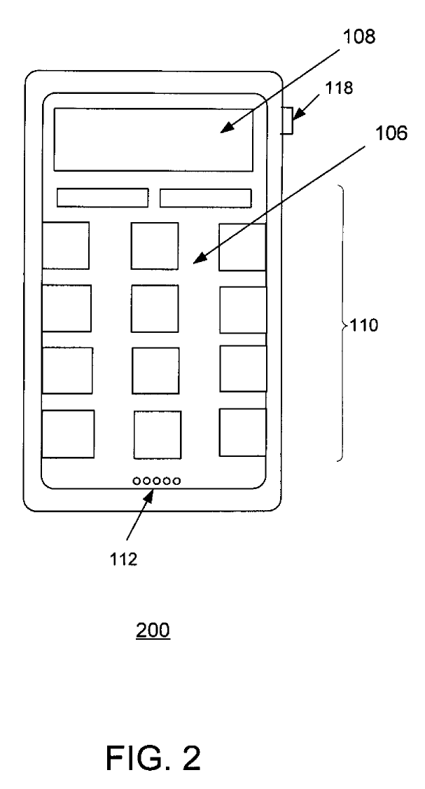

Referring now to FIG. 2, a perspective view of a cellular telephone with a magnification device and an illumination device in a closed position 200 according to at least one embodiment of the invention is illustrated. As previously discussed, a cellular telephone may include magnifier 106, keyboard 110, microphone 112, on/off button 118, and/or display 108. Since magnifier 106 may extend to encompass a large majority of the upper portion of the cellular telephone, when the upper portion and lower portion of the cellular telephone are in a closed position, magnifier 106 may be used as a “window” to view the lower portion of the cellular telephone. As shown, keyboard 110, microphone 112, display 108, and/or any additional components that may be associated with the lower portion of the cellular telephone may be viewed using magnifier 106 as such a “window.” In one embodiment, magnifier 106 may be configured to magnify display 108 when the upper portion and lower portion of the cellular telephone are in a closed position.

If, for example, magnifier 106 is associated with a translucent and/or colored material, one or more components associated with the lower portion of the cellular telephone may be viewed in light of the affect of the coloration of the material. In addition, on/off button 118 may be turned to an on position resulting in an illumination of the lower portion of the cellular telephone using one or more illuminators. If, for example, one or more illuminators are associated with one or more colored LEDs, the illumination of the lower portion of the cellular telephone may also be viewed in light of the effect of the one or more colored LEDs.

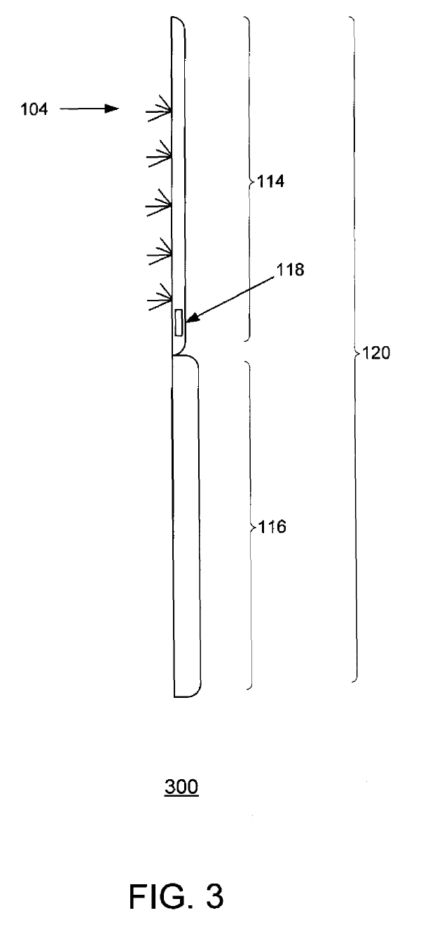

Referring now to FIG. 3, where a perspective view of a side of a cellular telephone with a magnification device and an illumination device in an open position 300 according to at least one embodiment of the invention is illustrated. As previously discussed, cellular telephone 120 may include upper portion 114 and lower portion 116. Upper portion 114 may include illuminator 104 and/or on/off button 118.

As shown, upper portion 114 may be hinged to lower portion 116 such that upper portion 114 and lower portion 116 may open to a 180° angle. Any hinging mechanism that may allow upper portion 114 and lower portion 116 to open to a 180° angle may be used to hinge upper portion 114 to lower portion 116. While in an open position, cellular telephone 120 may lay flush with an object of interest to be used as a magnification device and/or illumination device.

Illuminator 104 may be turned on (e.g., to illuminate) when upper portion 114 and lower portion 116 are in an open position. In various embodiments, illuminator 104 may illuminate toward a magnifier and away from a magnifier (e.g., toward an object of interest). Illuminator 104 may also be turned on using on/off button 118. For example, if illuminator 104 turns off because a predetermined amount of time has passed, a user of cellular telephone 120 may turn on illuminator 104 using on/off button 118.

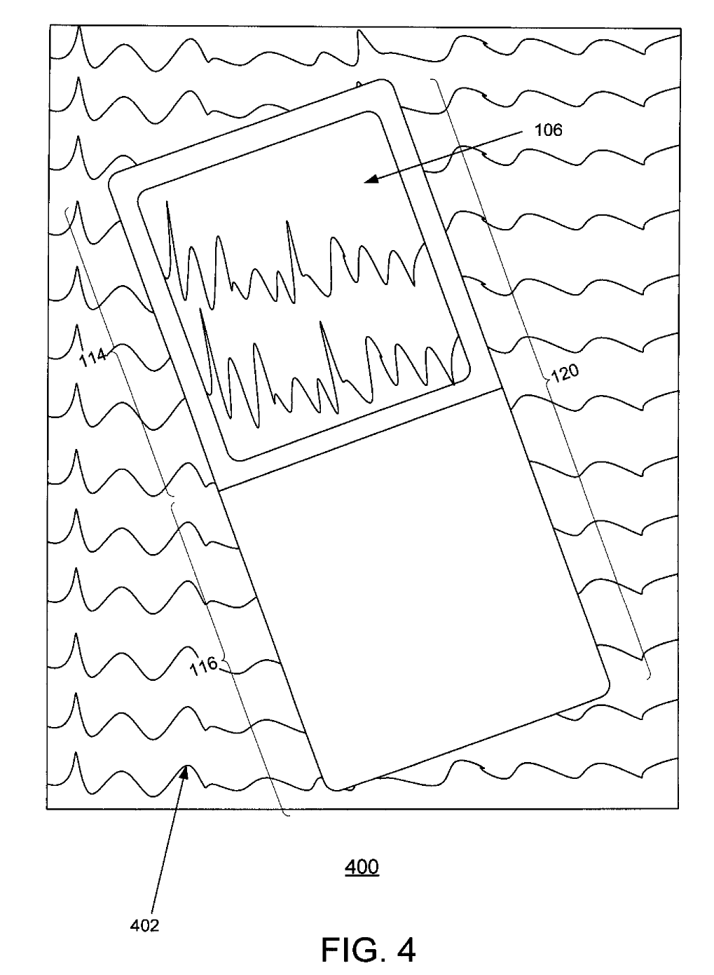

Referring now to FIG. 4, where an exemplary depiction of a top view of a cellular telephone with a magnification device and an illumination device while magnifying an object of interest in an open position 400 according to at least one embodiment of the invention is illustrated. As illustrated in FIG. 4, cellular telephone 120 may include upper portion 114 and lower portion 116. Upper portion 114 may include magnifier 106.

As shown, cellular telephone 120 may be used as a magnification device by laying cellular telephone 120 flush against object of interest 402 (e.g., paper with writing) and increasing and/or decreasing the distance between cellular telephone 120 and object of interest 402 according to the vision preferences of a user of cellular telephone 120. For example, a user of cellular telephone 120 may increase the magnification of object of interest 402 by increasing the distance between cellular telephone 120 and object of interest 402. A user of cellular telephone 120 may also decrease the magnification of object of interest 402 by decreasing the distance between cellular telephone 120 and object of interest 402.

Illuminator (not shown) may illuminate object of interest 402 and magnifier 106 by illuminating toward magnifier 106 and object of interest 402. It should be noted that this depiction is an example of how the various embodiments may be used.

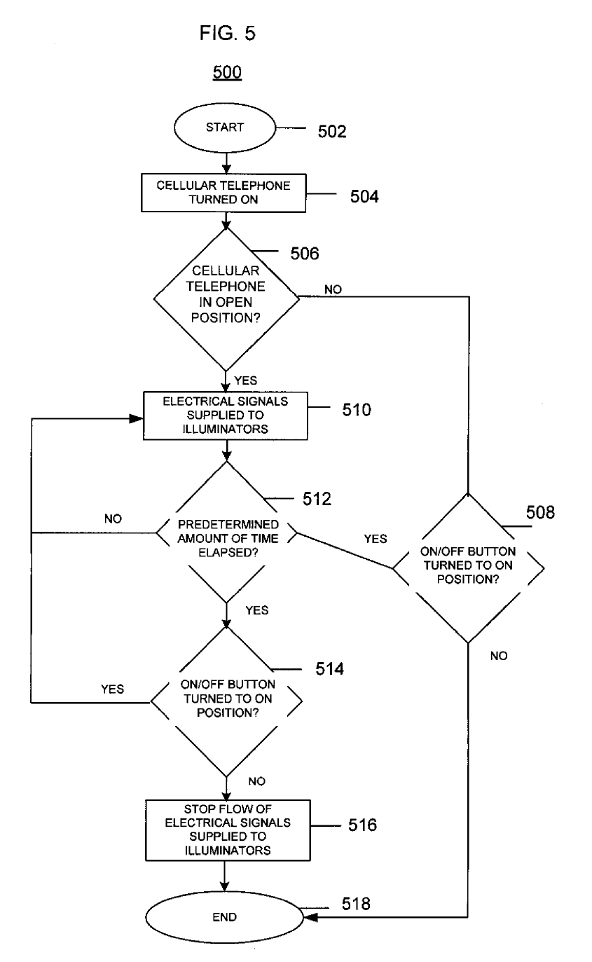

Referring now to FIG. 5, where an exemplary flowchart depicting the method of operation of one or more illuminators associated with a cellular telephone with a magnification device and an illumination device 500 according to at least on embodiment of the invention is illustrated. The method may be initiated in block 502. In block 504, a cellular telephone may be turned on. In block 506 a determination of whether a cellular telephone is in an open position may be made. In block 506, if it is determined that a cellular telephone is in the open position, the method may continue to block 510 and supply one or more electrical signals from a power source to one or more illuminators (e.g., turn one or more illuminators on). A cellular telephone may be determined to be in an open position using software and/or hardware (e.g., sensors) known to those of ordinary skill in the art.

If it is determined that a cellular telephone is not in an open position in block 506, the method may proceed to block 508. In block 508 a determination of whether an on/off button for one or more illuminators has been turned to an on position. In block 508, if it is determined that the on/off button for one or more illuminators has been turned to the on position, the method may proceed to block 510 and supply one or more electrical signals from the power source to one or more illuminators. If in block 508, however, it is determined that the on/off button for the one or more illuminators has not been turned to the on position, the method may proceed to block 518 and end. When one or more electrical signals have been supplied from the power source to one or more illuminators in block 510, it may be determined whether a predetermined amount of time has elapsed in block 512. If, for example, a predetermined amount of time has elapsed, the method may proceed to block 514. If in block 512, however, it has been determined that a predetermined amount of time has not elapsed, one or more electrical signals may continue to be supplied from the power source to one or more illuminators in block 510.

In block 514, a determination of whether the on/off button for the one or more illuminators has been turned to the on position may be made. If, for example, it is determined that the on/off button for the one or more illuminators has been turned to the on position, one or more electrical signals may continue to be supplied from the power source to one or more illuminators in block 510. If in block 514, however, it is determined that the on/of button for the one or more illuminators has been turned to the off position, the method may proceed to block 516.

In block 516, one or more electrical signals may not be supplied from the power source to one or more illuminators. The method may end in block 518.

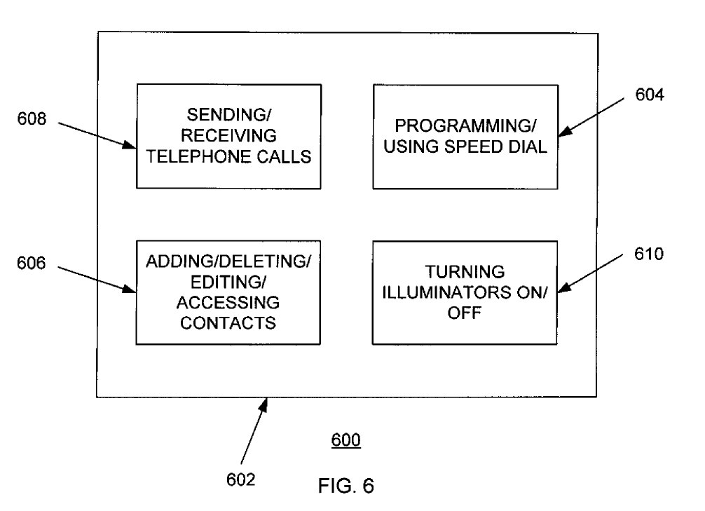

Referring now to FIG. 6, where an exemplary block diagram depicting one or more functions performed by an OS associated with a cellular telephone with a magnification device and an illumination device 600 according to at least one embodiment of the invention is illustrated. A cellular telephone with a magnification device may include an OS 602 configured to implement one or more basic functions. Basic functions may include sending and/or receiving telephone calls 608, adding, deleting, editing, and/or accessing a contacts list 606, programming and/or using speed dial 604, turning on and/or off one or more illuminators 610, and/or any other basic functions that may be associated with a cellular telephone's OS.

OS may include any software and/or hardware used to implement and/or control one or more functions associated with an electrical device.

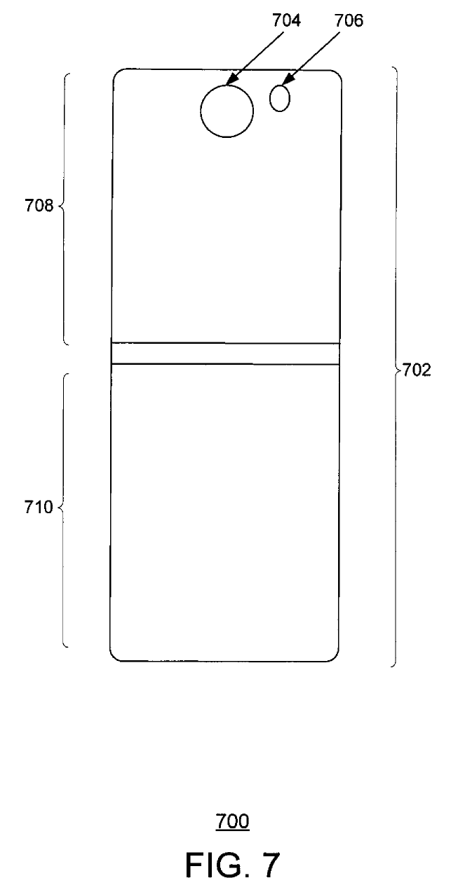

Referring now to FIG. 7, where a perspective view of the outward side of a cellular telephone with a magnification device and an illumination device 700 according to at least one embodiment of the invention is illustrated. Cellular telephone 702 may include upper portion 708 and/or lower portion 710. In various embodiments, upper portion 708 may be hinged to lower portion 710 such that upper portion 708 and lower portion 710 open to a 180° angle. In various embodiments, upper portion 708 and lower portion 710 may open to one or more angles less than a 180° angle. For example, upper portion 708 and lower portion 710 may open to a 160° angle. In another example, upper portion 708 and lower portion 710 may open to a 170° angle. In yet another example, upper portion 708 and lower portion 710 may open to a 150° angle. While upper portion 708 and lower portion 710 may be illustrated as extending lengthwise along a vertical axis, other configurations may be realized. For example, upper portion 708 and lower portion 710 may also extend lengthwise along a horizontal axis. In various embodiments, cellular telephone 702 may include a single portion (e.g., a single piece cellular telephone).

As illustrated in FIG. 7, the outward side of the upper portion 708 of the cellular telephone 702 may include a magnification device 704 and/or an illumination device 706. In various embodiments, the magnification device 704 may include a camera device such as one well-known in the art for focusing on and capturing one or more objects of interest. In various embodiments, the camera device of the magnification device 704 may utilize well-known camera phone technologies, such as: one or more Complementary metal-oxide-semiconductor (CMOS) sensors, one or more charged-couple device (CCD) sensors, and/or any other camera phone technology and/or image sensor technology that may be used to focus on and/or capture one or more objects of interest.

In various embodiments, the magnification device 704 may include one or more magnification lens. A magnification lens may include a lens made of a glass-type material, plastic-type material, polymer-type material, and/or any other material that may be used to enlarge the apparent size of one or more objects of interest. For example, a magnification lens may include a concave shape lens, a biconvex shape lens, a plano-convex shape lens, a convex-concave shape lens, a meniscus shape lens, a plano-concave shape lens, a biconcave shape lens, a fresnel shape lens, and/or any other lens shape that may be used to magnify an object of interest.

In various embodiments, the magnification device 704 may include one or more magnification lens of varying magnification strength. For example, the magnification device 704 may include a magnification lens with a magnification strength of 2×. In another example, the magnification device 704 may include a magnification lens with a magnification strength of 3×. In yet another example, the magnification device 704 may include a magnification lens with a magnification strength of 4×. In various embodiments, the magnification device 704 may include software and/or hardware configured to magnify one or more objects of interest focused on and/or captured by the magnification device 704.

In various embodiments, the illumination device 706 may include one or more illuminators, such as one or more LEDs and/or any other light source that may be used to illuminate an object of interest. In various embodiments, the illumination device 706 may be configured to operate while the magnification device 704 is in operation. In various embodiments, the illumination device 706 may be configured to operate in response to user input (e.g., user input of “on,” user input of “off”).

The illumination device 706 may provide a light source with varying degrees of power. For example, the illumination device 706 may be configured to provide a light source with high power (e.g., in areas with little light) based on user input. In another example, the illumination device 706 may be configured to provide a light source with medium power (e.g., in areas with medium light) based on user input. In yet another example, the illumination device 706 may be configured to provide a light source with low power (e.g., in areas with a lot of light) based on user input. In various embodiments, the OS of the cellular telephone 702 may enable a user to modify, edit, and/or set the amount of power to be used by the illumination device 706.

In various embodiments, the cellular telephone 702 and/or the illumination device 706 may be configured to determine the illumination intensity (e.g., amount of power) needed to illuminate and/or magnify a particular object of interest. The cellular telephone 702 may include one or more distance sensors, proximity sensors, and/or any other sensors used to determine the distance of an object of interest from the cellular telephone 702 (e.g., 5 inches, 1 foot, 3 feet). Based on the distance of the object of interest from the cellular telephone 702, the illumination device 706 may illuminate at a predetermined illumination intensity.

For example, the cellular telephone 702 may be configured to illuminate objects of interest that are at a distance of 6 inches or less at a first illumination intensity. In another example, the cellular telephone 702 may be configured to illuminate objects of interest that are at a distance of 6.1 inches to 1 foot at a second illumination intensity. In yet another example, the cellular telephone 702 may be configured to illuminate objects of interest at a distance of 3 feet at a third illumination intensity. In various embodiments, the designers of the cellular telephone 702 may pre-select one or more illumination intensities and/or one or more distances based on design preferences. Accordingly, the designers of the cellular telephone 702 may associate one or more pre-selected illumination intensities with one or more pre-selected distances.

By way of a non-limiting example, the camera device of the magnification device 704 and/or the illumination device 706 may enable a first user of the cellular telephone 702 to view, magnify, and/or illuminate a first object of interest, such as a finger. In another example, the camera device of the magnification device 704 and/or the illumination device 706 may enable a second user of the cellular telephone 702 to view, magnify, and/or illuminate a second object of interest, such as a news paper. In yet another example, the camera device of the magnification device 704 and/or the illumination device 706 may enable a third user of the cellular telephone 702 to view, magnify, and/or illuminate a third object of interest, such as a restaurant menu.

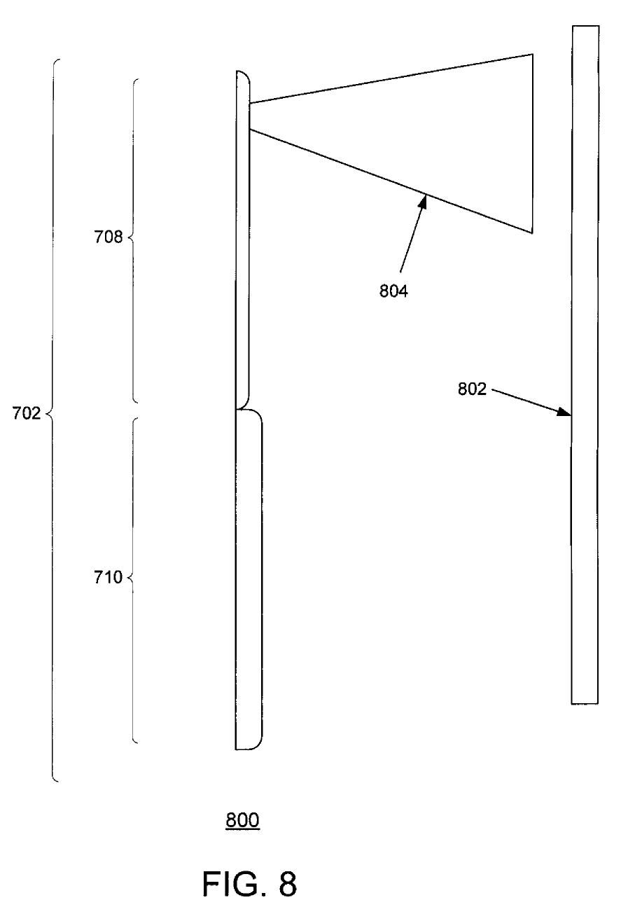

Referring now to FIG. 8, where another perspective view of a side of a cellular telephone with a magnification device and an illumination device in an open position 800 according to at least one embodiment of the invention is illustrated. By way of a non-limiting example, the magnification device 704 (not shown) and/or the illumination device 706 (not shown) of the cellular telephone 702 may enable a user to view, magnify, and/or illuminate an object of interest 802 as illustrated. In various embodiments, the user may point the outward side of the cellular telephone 702 toward the object of interest 802 (as illustrated). The user may also operate the illumination device 706 (not shown) using the graphical user interface associated with the OS in order to activate and/or modify a light source 804.

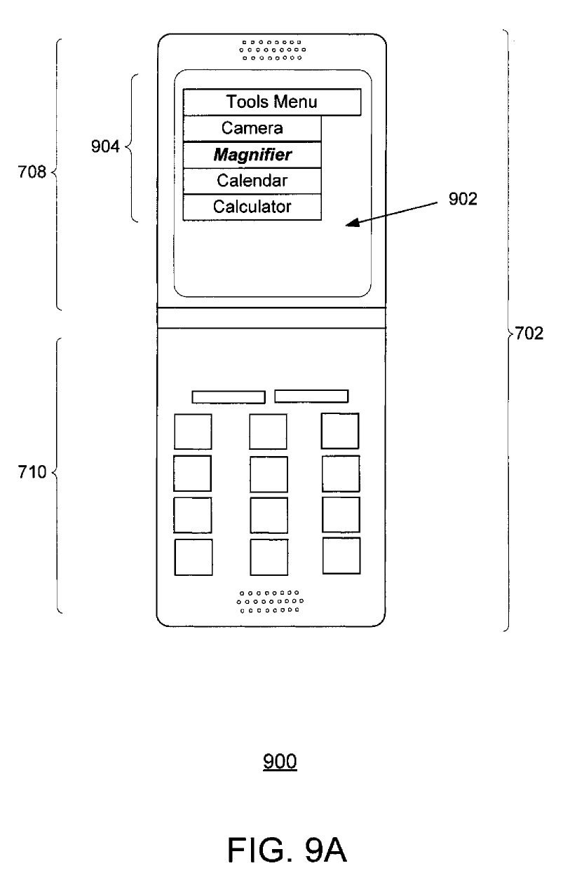

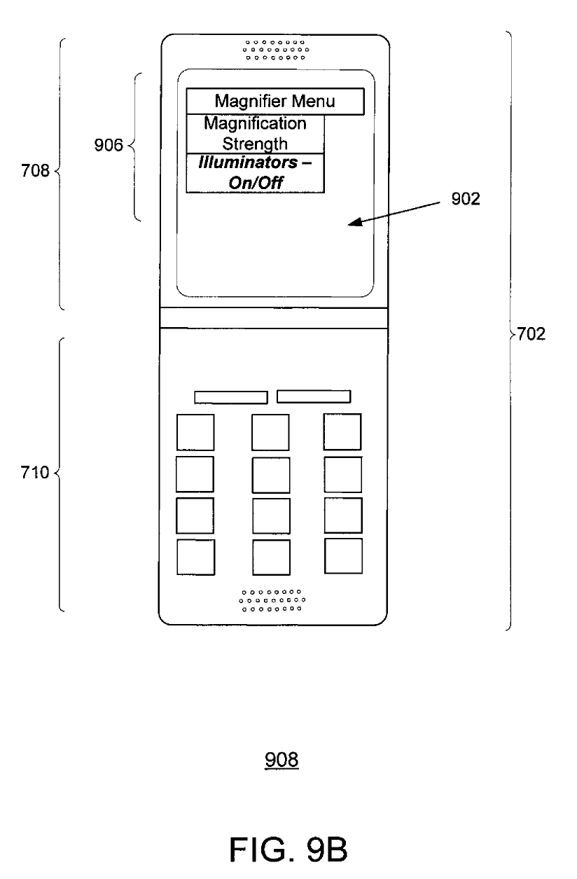

Referring now to FIG. 9A, where a perspective view of the inward side of a cellular telephone with a display device displaying an exemplary menu of functions of the cellular telephone 900 according to at least one embodiment of the invention is illustrated. As illustrated, the upper portion 708 of the cellular telephone 702 may include a display device 902. In various embodiments, the display device 902 may include one or more liquid crystal displays, plasma displays, and/or any other display device that is well-known in the art and may be used to display a graphical user interface and/or one or more objects of interest to a user. In various embodiments, the display device 902 may be coupled to the upper portion 708 of the cellular telephone 702 on the side that is opposite the magnification device 704 and/or the illumination device 706.

In various embodiments, the OS of the cellular telephone 702 may enable a user to access the magnification functions and/or the illumination functions of the cellular telephone 702 using a graphical user interface. For example, the graphical user interface may enable the user to access a “Tools Menu” 904 that displays (e.g., lists) one or more magnification functions and/or one or more illumination functions of the cellular telephone 702. The user may use an input device (e.g., the keyboard displayed in the lower portion 710 of the cellular telephone 702) of the cellular telephone 702 to select and/or activate one or more functions displayed (e.g., listed) on the “Tools Menu” 904.

Referring now to FIG. 9B, where a perspective view of the inward side of a cellular telephone with a display device displaying an exemplary menu of magnifier functions of the cellular telephone 908 according to at least one embodiment of the invention is illustrated. In various embodiments, the OS of the cellular telephone 702 may enable a user to access the magnification functions and/or the illumination functions of the cellular telephone 702 using a graphical user interface. For example, the graphical user interface may enable the user to access a “Magnifier Menu” 906 that displays (e.g., lists) one or more magnification functions and/or one or more illumination functions of the cellular telephone 702. The user may use an input device (e.g., the keyboard displayed in the lower portion 710 of the cellular telephone 702) of the cellular telephone 702 to select and/or activate one or more functions displayed (e.g., listed) on the “Magnifier Menu” 906. For example, the user may modify and/or set the magnification strength of the magnification device 704 using the “Magnifier Menu” 906. In another example, the user may activate and/or modify the illumination of the illumination device 706 using the “Magnifier Menu” 906.

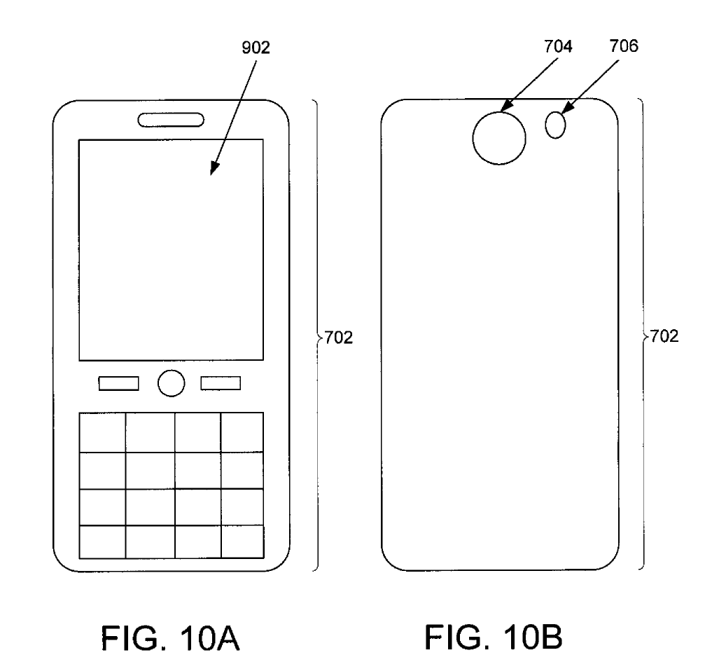

Referring now to FIG. 10A, where a perspective view of the front side of a single piece cellular telephone according to at least one embodiment of the invention is illustrated. As previously discussed, the cellular telephone 702 may include a single portion. Accordingly, the front side of the cellular telephone 702 may include the display device 902.

Referring now to FIG. 10B, where a perspective view of the back side of a single piece cellular telephone according to at least one embodiment of the invention is illustrated. As previously discussed, the cellular telephone 702 may include a single portion. Accordingly, the back side of the cellular telephone 702 may include the magnification device 704 and/or the illumination device 706.

In various embodiments, a cellular telephone with a magnification device, illumination device, and/or basic OS may be used for individuals with impaired vision, such as, senior citizens, individuals with a need for devices with simple functions, such as, mentally handicapped, and/or for individuals that desire the convenience of such devices being combined into a single device. Other applications and uses may be realized.

While the foregoing description includes many details and specificities, it is to be understood that these have been included for purposes of explanation only, and are not to be interpreted as limitations of the present inventions. Many modifications to the embodiments described above can be made without departing from the spirit and scope of the inventions.

The embodiments of the present inventions are not to be limited in scope by the specific embodiments described herein. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although some of the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

1. A cellular telephone device comprising:
a first side, the first side having:
a display device; and
a second side, the second side having:
a magnification device, the magnification device comprising a plurality of magnification lens internal to the magnification device; and
an illumination device, the illumination device comprising one or more illuminators;
wherein the first side is coupled to the second side such that the magnification device magnifies and the illumination illuminates in a direction opposite the display device.

2. The cellular telephone device according to claim 1, wherein the magnification device comprises a camera device.

3. The cellular telephone device according to claim 1, wherein each of the plurality of magnification lens are associated with a particular magnification strength.

4. The cellular telephone device according to claim 1, wherein the illumination device is positioned on the second side such that the illumination device is adjacent to the magnification device.

5. The cellular telephone device according to claim 1, wherein the illumination device, the magnification device, and the display device are configured to operate simultaneously.

6. The cellular telephone device according to claim 1, wherein the display device comprises at least one of a liquid crystal display and a plasma display.

7. The cellular telephone device according to claim 1, wherein the display device is coupled to the first side such that the display device is configured to display an object of interest to a user.

8. The cellular telephone device according to claim 7, wherein the display device is coupled to the first side such that the display device is configured to display the object of interest that is magnified by the magnification device to the user.

9. The cellular telephone device according to claim 7, wherein the display device is coupled to the first side such that the display device is configured to display the object of interest that is illuminated by the illumination device to the user.

10. A cellular telephone device comprising:
a first side, the first side having:
a display device; and
a second side, the second side having:
a camera device, the camera device comprising a plurality of magnification lens internal to the camera device;
an illumination device, the illumination device comprising one or more illuminators;
wherein the first side is coupled to the second side such that the camera device magnifies and the illumination illuminates in a direction opposite the display device.

11. The cellular telephone device according to claim 10, wherein each of the plurality of magnification lens are associated with a particular magnification strength.

12. The cellular telephone device according to claim 10, wherein the illumination device is positioned on the second side such that the illumination device is adjacent to the camera device.

13. The cellular telephone device according to claim 10, wherein the illumination device, the camera device, and the display device are configured to operate simultaneously.

14. The cellular telephone device according to claim 10, wherein the display device comprises at least one of a liquid crystal display and a plasma display.

15. The cellular telephone device according to claim 10, wherein the display device is coupled to the first side such that the display device is configured to display an object of interest to a user.

16. The cellular telephone device according to claim 15, wherein the display device is coupled to the first side such that the display device is configured to display the object of interest that is magnified by the camera device to the user.

17. The cellular telephone device according to claim 15, wherein the display device is coupled to the first side such that the display device is configured to display the object of interest that is illuminated by the illumination device to the user.

18. A cellular telephone device comprising:
a first side, the first side having:
a display device, the display device comprising at least one of a liquid crystal display and a plasma display; and
a second side, the second side having:
a camera device, the camera device comprising a plurality of magnification lens internal to the camera device;
an illumination device, the illumination device comprising one or more illuminators;
wherein the first side is coupled to the second side such that the camera device magnifies and the illumination illuminates in a direction opposite the display device.
